(19) United States
(12) Patent Application Publication
(10) Pub. No.: US 2012/0288688 A1
(43) Pub. Date: Nov. 15, 2012

(54) SCINTILLATOR PANEL AND METHOD OF MANUFACTURING THE SCINTILLATOR PANEL

(76) Inventors: Yun Bong Kug, Seoul (KR); Taekwon Hong, Seongnam (KR); Jaebok Song, Seoul (KR)

(21) Appl. No.: 13/466,703

(22) Filed: May 8, 2012

(30) Foreign Application Priority Data
May 9, 2011 (KR) 10-2011-0043433

(51) Int. Cl. B32B 3/08

(52) U.S. Cl. 428/177

(57) ABSTRACT

Disclosed is a scintillator panel, including a substrate, a scintillator layer formed on the substrate and including a plurality of columnar crystals so that radiation is converted into light at a predetermined wavelength, a dam structure formed on the substrate to be spaced apart by a predetermined interval from a peripheral edge of the scintillator layer, a protective layer formed on a surface of the scintillator layer, a surface of the substrate defined between the scintillator layer and the dam structure and a portion of a surface of the dam structure, a first coating layer formed on the protective layer to be disposed in a space between a peripheral surface of the scintillator layer and the dam structure, and a second coating layer formed on the first coating layer and the protective layer.

### BACKGROUND OF THE INVENTION

1. Field of the Invention

The present invention relates to a scintillator panel and a method of manufacturing the same.

2. Description of the Related Art

Conventional X-ray radiography, which has been carried out using films and screens, is problematic because it requires manpower and space to store the films. To solve this problem, attempts have been made to scan such films using a scanner to digitize them. However, this also unavoidably uses up film, undesirably doubling costs. Hence, a digital radiographic imaging apparatus has been introduced in which radiation is converted into an electrical signal using a detector in lieu of a film and such a signal is transmitted to a computer.

Types of digital radiographic imaging apparatuses are a direct conversion type and an indirect conversion type, depending on the type of conversion. The direct conversion type enables the irradiated X-rays to be directly converted into an electrical signal to detect an imaging signal. On the other hand, the indirect conversion type converts X-rays into visible light, which is then converted into an electrical signal using an image sensor such as a photodiode, CMOS (Complementary Metal-Oxide-Semiconductor) or CCD (Charged Coupled Device) thus producing an image. Because a high voltage has to be applied in the direct conversion type for the radiation image to be detected, the indirect conversion type is mainly used.

An example of a detector based on the indirect conversion type includes an X-ray detector. This X-ray detector includes a radiation image sensor for forming an image using X-rays that have passed through a target. The following is a description of how a radiation image sensor produces an image. An X-ray passes through a target and is converted into light by means of a scintillator provided on an input surface of the image sensor. The light thus converted is converted again into photoelectrons, which are then amplified by an inner electron gun, and the amplified photoelectrons collide with a fluorescent material of an output unit and are thus converted into visible light. The converted visible light is converted into an electrical signal by means of a light-receiving element such as a photodiode, etc., so that an image is formed in response to the signal thus converted.

Methods of manufacturing the radiation image sensor used in the X-ray detector are broadly classified into an indirect deposition method and a direct deposition method. In the indirect deposition method, a scintillator layer and a protective layer made of Parylene are sequentially formed on an aluminum substrate through which radiation passes and from which visible light reflects, thus separately preparing a scintillator panel, and the scintillator panel is integratedly attached to an imaging device using an optical adhesive, the imaging device comprising a plurality of light-receiving elements arranged on the central surface of a glass substrate and a plurality of electrode pads disposed on the marginal surface of the glass plate and electrically connected to the light-receiving elements.

On the other hand, in the direct deposition method, the scintillator is directly deposited on the surface of an imaging device comprising a plurality of light-receiving elements arranged on the central surface of a glass plate and a plurality of electrode pads disposed on the marginal surface of the glass plate and electrically connected to the light-receiving elements, thus forming a scintillator layer, and a protective layer made of Parylene is formed over the entire surface of the imaging device including the scintillator layer, and a reflective layer made of aluminum is formed on the protective layer, thereby manufacturing an image sensor.

FIG. 1 illustrates a partial cross-section of a conventional scintillator panel.

FIG. 1 corresponds to the scintillator panel according to both the direct deposition method and the indirect deposition method. As illustrated in FIG. 1, the conventional scintillator panel is configured such that a scintillator layer 200 is formed on a substrate 100, a dam 300 is formed on the substrate 100 to be disposed around the scintillator layer 200, and a protective layer 400 made of Parylene is formed to cover the entire surface of the scintillator layer 200 and a portion of the surface of the dam 300.

CsI, which is used to form the scintillator layer 200, is a hygroscopic material, and acts to absorb water vapor (moisture) from the air, so that the layer 200 dissolves in the water vapor. Hence, the scintillator layer 200 must be blocked from moisture. In such a conventional scintillator panel 200, the protective layer 400 is formed on the scintillator layer 200. As such, because the peripheral surface of the scintillator layer 200 is inclined, the protective layer 400 is formed along the inclined peripheral surface of the scintillator layer 200. The inclined peripheral surface of the scintillator layer 200 is more susceptible to moisture, compared to the other portions. Thus, as moisture may directly penetrate into the inclined surface of the protective layer 400, the scintillator layer 200 may undesirably dissolve in moisture that is absorbed.

Furthermore, moisture may penetrate into the interface between the dam 300 and the protective layer 400, undesirably causing problems in which the scintillator layer 200 may undesirably dissolve in moisture that is absorbed.

Furthermore, moisture may directly penetrate into the dam 300 or may penetrate into the interface between the substrate 100 and the dam 300, undesirably causing problems in which the scintillator layer 200 may undesirably dissolve in moisture that is absorbed.

Accordingly, there is required a scintillator panel which is able to effectively prevent moisture from penetrating.

Meanwhile as illustrated in FIG. 1, flatness of the entire scintillator panel is not uniform because of the inclined peripheral surface of the scintillator layer 200, undesirably causing defects in subsequent processes.

### SUMMARY OF THE INVENTION

Accordingly, the present invention has been made keeping in mind the above problems occurring in the related art, and an object of the present invention is to provide a scintillator panel which may prevent moisture from penetrating and may have uniform flatness, and a radiation image sensor including the scintillator panel.

In order to accomplish the above object, an aspect of the present invention provides a scintillator panel, comprising a substrate; a scintillator layer formed on the substrate and comprising a plurality of columnar crystals so that radiation is converted into light at a predetermined wavelength; a dam structure formed on the substrate to be spaced apart by a predetermined interval from a peripheral edge of the scintillator layer; a protective layer formed on a surface of the scintillator layer, a surface of the substrate defined between the scintillator layer and the dam structure, and a portion of a surface of the dam structure; a first coating layer formed on the protective layer to be disposed in a space between a peripheral surface of the scintillator layer and the dam structure; and a second coating layer formed on the first coating layer and the protective layer.

In this aspect, the dam structure may comprise a first dam formed on the substrate around the peripheral edge of the scintillator layer and a second dam formed on the first dam.

In this aspect, the dam structure may comprise a first dam formed on the substrate around the peripheral edge of the scintillator layer, a second dam formed around the first dam, and a third dam formed on the first dam and the second dam.

As such, the first dam may be formed to be lower than a maximum height of the scintillator layer, and the second dam may be formed to be higher than the maximum height of the scintillator layer.

Also, the protective layer may be formed on a portion of a surface of the first dam, and the first coating layer may be formed in a space between the peripheral surface of the scintillator layer and the second dam.

Furthermore, the second dam may be spaced apart by a predetermined interval from an outer surface of the first dam.

Furthermore, the first coating layer may be formed between the first dam and the second dam.

In this aspect, the dam structure may comprise a first dam formed on the substrate around the peripheral edge of the scintillator layer, a second dam formed around the first dam, a third dam formed around the second dam, and a fourth dam formed on the first dam, the second dam and the third dam.

As such, the first dam may be formed to be lower than a maximum height of the scintillator layer, and the second dam may be formed to be higher than the maximum height of the scintillator layer.

Furthermore, the protective layer may be formed on a portion of a surface of the first dam, and the first coating layer may be formed in a space between the peripheral surface of the scintillator layer and the second dam.

In this aspect, a reflective layer may be formed on the second coating layer, and the reflective layer may comprise particles for reflecting the light at a predetermined wavelength, the particles comprising at least one selected from among TiO₂, LiF, MgF₂, SiO₂, Al₂O₃, MgO, SiN, CaF₂, NaCl, KBr, KCl, AgCl, SiNO₃, Au, SiO, AlO, B₄C, and BNO₃.

In this aspect, the protective layer may comprise Parylene.

In this aspect, the first coating layer may comprise a UV curable resin.

As such, the UV curable resin may be any one selected from among an ethylenically unsaturated urethane acrylate resin, an ethylenically unsaturated polyester acrylate resin, and an ethylenically unsaturated epoxy acrylate, each of which has an ethylenically unsaturated functional group.

In this aspect, the first coating layer may comprise a thermosetting resin.

As such, the thermosetting resin may be any one selected from among an acrylic resin, an epoxy resin, a polyester resin, a melamine resin, a urea resin, and a urethane resin.

In this aspect, the second coating layer may comprise a thermosetting resin.

As such, the thermosetting resin may be any one selected from among an acrylic resin, an epoxy resin, a polyester resin, a melamine resin, a urea resin, and a urethane resin.

Another aspect of the present invention provides a scintillator panel, comprising a substrate; a scintillator layer formed on the substrate and comprising a plurality of columnar crystals so that radiation is converted into light at a predetermined wavelength; a protective layer formed on the scintillator layer and an entire surface of the substrate; a dam structure formed on the protective layer around a peripheral edge of the scintillator layer; a first coating layer formed on the protective layer to be disposed in a space between a peripheral surface of the scintillator layer and the dam structure; and a second coating layer formed on the first coating layer and the protective layer.

In this aspect, the dam structure may comprise a first dam formed on the substrate around the peripheral edge of the scintillator layer and a second dam formed on the first dam.

As such, the second dam may be formed to be higher than the first dam.

In this aspect, the protective layer may comprise Parylene.

In this aspect, the first coating layer may comprise a UV curable resin.

As such, the UV curable resin may be any one selected from among an ethylenically unsaturated urethane acrylate resin, an ethylenically unsaturated polyester acrylate resin, and an ethylenically unsaturated epoxy acrylate, each of which has an ethylenically unsaturated functional group.

In this aspect, the first coating layer may comprise a thermosetting resin.

As such, the thermosetting resin may be any one selected from among an acrylic resin, an epoxy resin, a polyester resin, a melamine resin, a urea resin, and a urethane resin.

In this aspect, the second coating layer may comprise a thermosetting resin.

As such, the thermosetting resin may be any one selected from among an acrylic resin, an epoxy resin, a polyester resin, a melamine resin, a urea resin, and a urethane resin.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a partial cross-section of a conventional scintillator panel;

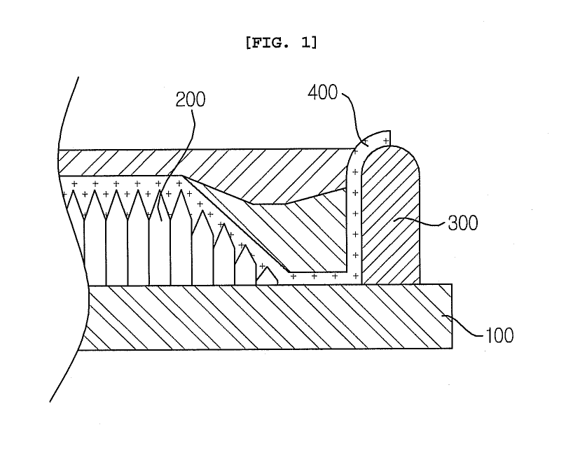

FIG. 2 illustrates a cross-section of a scintillator panel according to a first embodiment of the present invention;

FIG. 3 illustrates a cross-section of a scintillator panel according to a second embodiment of the present invention;

FIG. 4 illustrates a cross-section of a scintillator panel according to a third embodiment of the present invention;

FIG. 5 illustrates a cross-section of a scintillator panel according to a fourth embodiment of the present invention;

FIG. 6 illustrates a cross-section of a scintillator panel according to a fifth embodiment of the present invention;

FIG. 7 illustrates a cross-section of a scintillator panel according to a sixth embodiment of the present invention; and

FIG. 8 illustrates a cross-section of a scintillator panel according to a seventh embodiment of the present invention,

### DESCRIPTION OF SPECIFIC EMBODIMENTS

Hereinafter, preferred embodiments of the present invention regarding a scintillator panel will be described in detail with reference to the accompanying drawings. Wherever possible, the same reference numerals will be used throughout the drawings and the description to refer to the same or like components. In the following description, it is to be noted that, when a detailed description of configurations or functions related to the present invention may make the gist of the present invention unclear, they will be omitted.

Below is a description of a scintillator panel according to a first embodiment of the present invention.

### First Embodiment

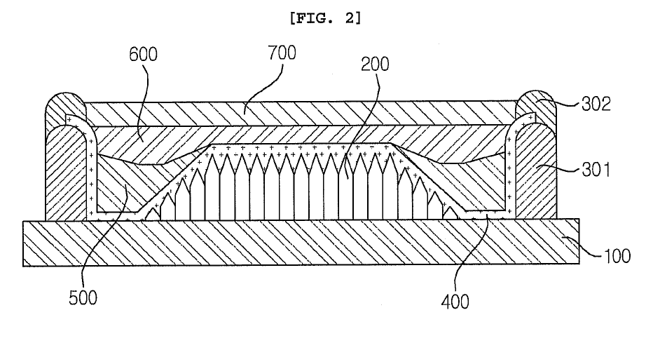

FIG. 2 illustrates a cross-section of the scintillator panel according to the first embodiment of the present invention. As illustrated in FIG. 2, the scintillator panel according to the first embodiment of the present invention comprises a substrate 100; a scintillator layer 200 formed on the substrate and comprising a plurality of columnar crystals so that radiation is converted into light at a predetermined wavelength; a dam structure 301, 302 formed on the substrate to be spaced apart by a predetermined interval from the peripheral edge of the scintillator layer; a protective layer 400 formed on the surface of the scintillator layer 200, the surface of the substrate 100 defined between the scintillator layer 200 and the dam structure 301, 302, and a portion of the surface of the dam structure 301, 302; a first coating layer 500 formed on the protective layer 400 to be disposed in a space between the peripheral surface of the scintillator layer 200 and the dam structure 301, 302; a second coating layer 600 formed on the first coating layer 500 and the protective layer 400; and a reflective layer 700 formed on the second coating layer 600. As such, the dam structure 301, 302 includes a first dam 301 and a second dam 302 formed on the first dam 301.

The protective layer 400 functions to protect the scintillator layer 300 from the outside, and in particular plays a role of a moisture barrier which prevents moisture from penetrating into the scintillator layer 200.

The substrate 100 includes a light-receiving unit comprising light-receiving elements arranged on the surface of the substrate 100, and an electrode unit comprising electrode pads disposed on the marginal region of the surface of the substrate 100. More specifically, the light-receiving unit comprises a plurality of light-receiving elements one- or two-dimensionally arranged on a Si substrate or a glass substrate to perform photoelectric conversion. When the radiation incident on the scintillator layer 200 is converted into light by means of the scintillator layer 200, the light-receiving elements detect the converted light so that such light is converted into an electrical signal. Examples of the light-receiving elements may include a photodiode (PD) made of amorphous Si, a thin film transistor (TFT), CCD (Charged Coupled Device), CMOS (Complementary Metal-Oxide-Semiconductor) sensors, FOP (Fiber Optical Plate), etc.

The electrode unit comprises a plurality of electrode pads formed on the marginal region of the surface of the substrate 100 outside the light-receiving unit, and the electrode pads function to read an electrical signal generated by the light-receiving elements to transmit such a signal to an image analyzer, etc., and are electrically connected to the light-receiving elements using wires or the like which are not shown in FIG. 2.

Provided on the light-receiving unit is the scintillator layer 200 which enables the incident radiation to be converted into light at a wavelength which is detectable by the light-receiving elements and which is provided in the form of a columnar structure.

In the present specification, light is not limited to visible light, but is a concept including electromagnetic waves such as UV light, IR light, predetermined radiation, etc. The scintillator layer 200 is preferably formed to cover the entire surface of the light-receiving elements and the peripheral region thereof.

To form the scintillator layer 200, any material may be used without particular limitation so long as it may convert the radiation into light at a specific wavelength, and specific examples thereof may include CsI, Tl-doped CsI, Na-doped CsI, Tl-doped NaI, etc. Particularly useful is Tl-doped CsI which emits visible light and has good light emission efficiency.

The scintillator layer 200 is provided in the form of a plurality of columns. The columns of the scintillator layer 200 may grow irregularly using a deposition process, so that irregularities are present on the surface of the scintillator layer 200. The thickness of the scintillator layer 200 is about 20˜2000 μm.

CsI, which is typically used to form the scintillator layer 200, is a hygroscopic material, and absorbs water vapor (moisture) from the air, so that the layer 200 may dissolve in the water vapor. When damage occurs to the scintillator layer 200 due to moisture absorption, the resolution of the radiation image sensor may deteriorate, and thus a structure is required to protect the scintillator from moisture. Therefore, the scintillator panel according to the present invention is configured such that the protective layer 400 is formed so that the scintillator layer 200 is made airtight.

The protective layer 400 is preferably formed to cover the entire surface of the scintillator layer 200 and the peripheral region thereof.

To form the protective layer 400, any material may be used without particular limitation so long as radiation (X-rays) may pass therethrough and water vapor may be blocked thereby; preferably an organic resin, more preferably a Parylene based resin is used. Parylene is a trade name of polyparaxylene polymer deposited chemically, and may include Parylene N, Parylene C, Parylene D, Parylene AF-4, etc. A coating film using Parylene prevents the penetration of almost all of the water vapor and gas and has high water proofness and chemical resistance. The properties of this coating film are adapted for the protective layer to the extent that it has electrical insulation properties even in the form of a thin film and also that it allows radiation and visible light to pass therethrough.

Parylene may be applied using chemical vapor deposition (CVD) which performs deposition on a support in a vacuum, like the vacuum deposition of metal. Specifically, quenching a thermal decomposition product of a diparaxylene monomer in an organic solvent such as toluene, benzene, etc. to obtain diparaxylene which is referred to as a dimer, thermally decomposing the dimer to produce a stable radical paraxylene gas, and adsorbing the generated gas onto a substrate and polymerizing it to yield a polyparaxylene film having a molecular weight of about 5×10⁵ may be carried out.

The scintillator panel according to the first embodiment of the present invention is manufactured by forming the scintillator layer 200 on the substrate 100, and forming the first dam 301 on the substrate 100 to be spaced apart by a predetermined interval from the peripheral edge of the scintillator layer 200.

Before the protective layer 400 is formed, a masking layer is formed to protect the electrode unit disposed on the surface of an imaging device separated from the peripheral edge of the scintillator layer 200, and the protective layer 400 is formed on the surface of the substrate 100 having the masking layer.

The protective layer 400 is cut along the first dam 301 positioned around the peripheral edge of the scintillator layer 200, and the masking layer and the protective layer 400 formed thereon are removed. Thereby, the protective layer 400 only exists up to a portion of the surface of the first dam 301.

The masking layer plays a role in preventing the protective layer 400 from being formed on the electrode unit in the course of forming the protective layer. The shape or material of the masking layer is not limited so long as it does not deteriorate the electrical properties of the electrode unit and may prevent the protective layer 400 from being directly deposited on the electrode unit, and also so long as it may be easily removed from the electrode unit upon removing the formed protective layer 400.

Specifically, UV tape, a thermosetting resin, etc. may be used, and a jig structure may be used as in a fourth embodiment which will be described later. Particularly useful is UV tape. This UV tape functions to protect the surface of the substrate 100, and also allows an adhesive force to instantly disappear when irradiated with UV light, and thus may be stripped while applying almost no stress to the surface of the substrate 100. This tape contains a very small amount of impurities and thus does not contaminate the substrate and may effectively protect the surface of the substrate. Commercially available UV tape may include SP series available from Furukawa. When UV tape is used as the masking layer, the protective layer 400 is cut, the masking layer is irradiated with UV light so that the UV adhesive force is lost, and the masking layer and the protective layer formed thereon are stripped, thereby easily removing the protective layer without damaging the surface of the substrate nor the electrode unit.

Cutting the protective layer 400 and removing the masking layer and the protective layer formed thereon may be easily performed without damaging the surface of the substrate nor the electrode unit by cutting the protective layer 400, irradiating the masking layer with UV light to cause the UV tape to lose its adhesive force, and stripping the masking layer and the protective layer 400 formed thereon.

Also, the process of cutting the protective layer 400 is not limited by any particular limitation so long as the process uniformly and easily cuts the protective layer 400. Specifically, good examples are cutting using a cutter or laser trimming. Particularly useful is laser trimming. The cutting process using laser trimming may result in more precise control and a faster cutting rate, compared to when using a cutter, so that the protective layer 400 may be uniformly cut at an accurate position and depth.

When the protective layer 400 is cut and removed in this way, as illustrated in FIG. 2, the protective layer 400 is formed on the surface of the scintillator layer 200 and the area therearound, and a portion of the surface of the first dam 301.

The first coating layer 500 is formed on the protective layer 400 to be disposed in a space between the peripheral surface of the scintillator layer 200 and the first dam 301.

Also, the second coating layer 600 is formed on the first coating layer 500 and the protective layer 400 on which no first coating layer 500 was formed, after which the second dam 302 is formed on the first dam 301.

After formation of the second dam 302, the reflective layer 700 is formed on the second coating layer 600.

The second dam 302 covers the portion of the surface of the first dam 301 from which the protective layer 400 was removed so as to prevent the penetration of moisture, and also is provided in the form of a wall having a predetermined height around the reflective layer 700 which is to be formed, thus defining a space in which the reflective layer 700 may be formed.

As the material for forming the dam structure 301, 302, any resin may be used without particular limitation so long as it has high adhesive force and may form a rigid frame. Specific examples thereof include a silicone resin, an acrylic resin, and an epoxy resin. Particularly useful is a UV curable resin. For example, the dam structure 301, 302 may be formed by applying a UV curable resin and then curing it using UV light.

The first coating layer 500 and the second coating layer 600 compensate for the inclined peripheral surface of the scintillator layer 200, so that the flatness of the reflective layer 700 formed on the second coating layer 600 is made uniform. When the flatness of the reflective layer 700 is maintained uniform in this way, the defective rates of the scintillator panel may be decreased.

The first coating layer 500 and the second coating layer 600 may be formed using a thermosetting resin or a UV curable resin.

The thermosetting resin may be any one selected from among an acrylic resin, an epoxy resin, a polyester resin, a melamine resin, a urea resin, and a urethane resin.

In the case of acrylic resin, for example, a composition comprising 100 parts by weight of an acrylic resin, 10-50 parts by weight of a curing agent, 150 parts by weight of a solvent and 1 part by weight of an additive may be prepared and applied thus forming the first coating layer 500.

Examples of the solvent may include a low-boiling-point solvent and a high-boiling-point solvent. Examples of the low-boiling-point solvent may include methylethylketone and ethylacetate, which may be used alone or in combination, and examples of the high-boiling-point solvent may include butylacetate, benzene, toluene, xylene, butylcellosolve, etc., which may be used alone or in combination. The solvent is not limited to the examples listed above, and may be used without particular limitation so long as it may uniformly dissolve the compound and may impart chemical stability and does not react with the compound.

The additive functions to suppress the generation of foam and imparts a superior outer appearance upon forming a film, and may include for example silicone series, fluorine series, acryl series, etc.

Also, the UV curable resin may be mixed with a monomer having a large amount of an ethylenically unsaturated functional group, a radical initiator which produces a radical upon irradiation with UV light, a solvent and an additive, thus preparing a composition, which is then applied using wet coating, thereby forming the first coating layer 500 or the second coating layer 600. The solvent and the additive which are the same as those employed in the above thermosetting resin may be used.

The DV curable resin is an oligomer having two or more ethylenically unsaturated functional groups with a weight average molecular weight of 2×10³˜2×10⁴, and may be any one selected from among an ethylenically unsaturated urethane acrylate resin, an ethylenically unsaturated polyester acrylate resin, and an ethylenically unsaturated epoxy acrylate, each of which has the ethylenically unsaturated functional groups.

In the case of the DV curable resin, a composition comprising 100 parts by weight of the above oligomer, 50 parts by weight of the above monomer, 5 parts by weight of the radical initiator, 150 parts by weight of the solvent, and 1 part by weight of the additive may be prepared.

The wet coating process may be performed using any one selected from among spin coating, gravure coating, spray coating, dip coating, flow coating, screen printing, roll coating, bar coating, curtain coating, die coating, and knife coating. The type of wet coating process may be appropriately selected depending on the kind of target which is to be coated.

The reflective layer 700 may be formed using a material which enables radiation to pass therethrough and visible light to be reflected. The reflective layer 700 may include a metal layer having predetermined reflectivity for visible light, such as Al, Ag, Cr, Cu, Ni, Ti, Mg, Ph, Pt and Au, or a dielectric multilayer.

The reflective layer 700 may be formed using metal CVD, PVD (Physical Vapor Deposition), sputtering, ion beam deposition or plasma-enhanced CVD.

A scintillator panel according to a second embodiment of the present invention is described below.

### Second Embodiment

In the second embodiment of the present invention, portions of the description which would overlap with those of the first embodiment are omitted.

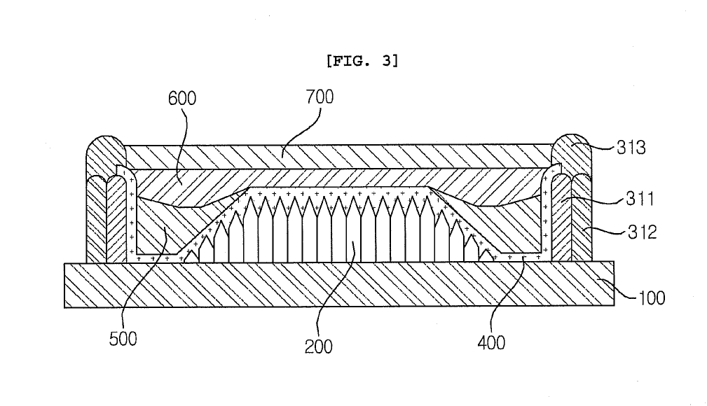

FIG. 3 illustrates a cross-section of the scintillator panel according to the second embodiment of the present invention. As illustrated in FIG. 3, the scintillator panel according to the second embodiment of the present invention is configured such that a scintillator layer 200 is formed on a substrate 100, a first dam 311 is formed on the substrate 100 to be spaced apart by a predetermined interval from the peripheral edge of the scintillator layer 200, and a second dam 312 is positioned around the first dam 311. As such, the sequence of forming the scintillator layer 200, forming the second dam 312 and then forming the first dam 311 inside the second dam 312 is possible. As shown in FIG. 3, the first dam 311 and the second dam 312 have the same height and width, which is merely illustrative, and the height and width may vary depending on the process productivity and efficiency.

Before a protective layer 400 is formed, a masking layer is formed to protect an electrode unit on the surface of an imaging device separated from the peripheral edge of the scintillator layer 200, and the protective layer 400 is formed on the surface of the substrate 100 having the masking layer.

The protective layer 400 is cut along the first dam 311 positioned around the peripheral edge of the scintillator layer 200, and the masking layer and the protective layer 400 formed thereon are removed. Thereby, the protective layer 400 only exists up to a portion of the surface of the first dam 311.

Cutting the protective layer 400 and removing the masking layer and the protective layer 400 formed thereon may be easily performed without damaging the surface of the substrate nor the electrode unit by cutting the protective layer 400, irradiating the masking layer with UV light to cause the UV tape to lose its adhesive force, and stripping the masking layer and the protective layer 400 formed thereon.

The process of cutting the protective layer 400 is not limited by any particular limitation so long as the process uniformly and easily cuts the protective layer 400, and specifically, cutting may be carried out using a typical cutter, laser trimming, etc. Particularly useful is laser trimming. Cutting using laser trimming may result in more precise cutting and a faster cutting rate compared to when using a typical cutter, so that the protective layer 400 may be uniformly cut at an accurate position and depth.

When the protective layer 400 is cut and removed in this way, the protective layer 400 is formed on the surface of the scintillator layer 200 and the area therearound, and a portion of the surface of the first dam 311, as illustrated in FIG. 3.

Also, a first coating layer 500 is formed on the protective layer 400 to be disposed in a space between the peripheral surface of the scintillator layer 200 and the first dam 311.

Further, a third dam 313 is formed on the first dam 311 and the second dam 312, and a second coating layer 600 is formed on the first coating layer 500 and the protective layer 400 on which no first coating layer 500 was formed, and a reflective layer 700 is formed on the second coating layer 600.

The third dam 313 covers the portion of the surface of the first dam 311 from which the protective layer 400 was removed so as to prevent the penetration of moisture, and also is provided in the form of a wall having a predetermined height around the reflective layer 700 which is to be formed, thus defining a space in which the reflective layer 700 may be formed.

The first coating layer 500 and the second coating layer 600 compensate for the inclined peripheral surface of the scintillator layer 200, so that the flatness of the reflective layer 700 formed on the second coating layer 600 is made uniform. When the flatness of the reflective layer 700 is maintained uniform in this way, the defective rates of the scintillator panel may be reduced.

A scintillator panel according to a third embodiment of the present invention is described below.

### Third Embodiment

In the third embodiment of the present invention, portions of the description which would overlap with those of the first embodiment are omitted.

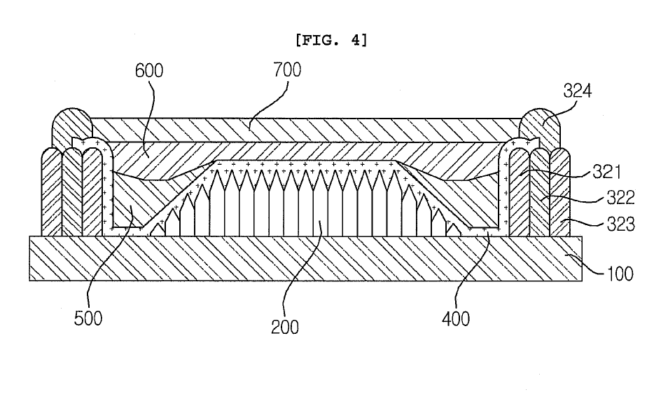

FIG. 4 illustrates a cross-section of the scintillator panel according to the third embodiment of the present invention. As illustrated in FIG. 4, the scintillator panel according to the third embodiment of the present invention is configured such that a scintillator layer 200 is formed on a substrate 100, a first dam 321 is formed on the substrate 100 to be spaced apart by a predetermined interval from the peripheral edge of the scintillator layer 200, a second dam 322 is formed around the first dam 321, and a third dam 323 is formed around the second dam 322. As such, the sequence of formation of the first dam 321, the second dam 322 and then the third dam 323 is not necessarily limited to the above, and the sequence of formation of the first dam 321 to the third dam 323 may be altered.

As shown in FIG. 4, the first dam 321, the second dam 322 and the third dam 323 have the same height and width, which is merely illustrative, and the height and width may vary depending on process productivity and efficiency.

Before a protective layer 400 is formed, a masking layer is formed to protect an electrode unit on the surface of an imaging device separated from the peripheral edge of the scintillator layer 200, and the protective layer 400 is formed on the surface of the substrate 100 having the masking layer.

The protective layer 400 is cut along the second dam 322 positioned around the peripheral edge of the scintillator layer 200, and the masking layer and the protective layer 400 formed thereon are removed. Thereby, the protective layer 400 only exists up to a portion of the surface of the second dam 322.

Cutting the protective layer 400 and removing the masking layer and the protective layer 400 formed thereon may be easily performed without damaging the surface of the substrate nor the electrode unit by cutting the protective layer 400, irradiating the masking layer with UV light to cause the UV tape to lose its adhesive force, and stripping the masking layer and the protective layer 400 formed thereon.

When the protective layer 400 is cut and removed in this way, the protective layer 400 is formed on the surface of the scintillator layer 200 and the area therearound, and the portion of the surface of the second dam 322, as illustrated in FIG. 4.

Also, a first coating layer 500 is formed on the protective layer 400 to be disposed in a space between the peripheral surface of the scintillator layer 200 and the first dam 321.

Further, a second coating layer 600 is formed on the first coating layer 500 and the protective layer 400 on which no first coating layer 500 was formed, and a fourth dam 324 is formed on the first dam 321, the second dam 322 and the third dam 323.

Also, a reflective layer 700 is formed on the second coating layer 600.

The fourth dam 324 covers the portion of the surface of the second dam 322 from which the protective layer 400 was removed so as to prevent the penetration of moisture, and also is provided in the form of a wall having a predetermined height around the reflective layer 700 which is to be formed, thus defining a space in which the reflective layer 700 may be formed.

The first coating layer 500 and the second coating layer 600 compensate for the inclined peripheral surface of the scintillator layer 200, so that the flatness of the reflective layer 700 formed on the second coating layer 600 is made uniform. When the flatness of the reflective layer 700 is maintained uniform in this way, the defect rates of the scintillator panel may be reduced.

A scintillator panel according to a fourth embodiment of the present invention is described below.

### Fourth Embodiment

In the fourth embodiment of the present invention, portions of the description which would overlap with those of the first embodiment are omitted.

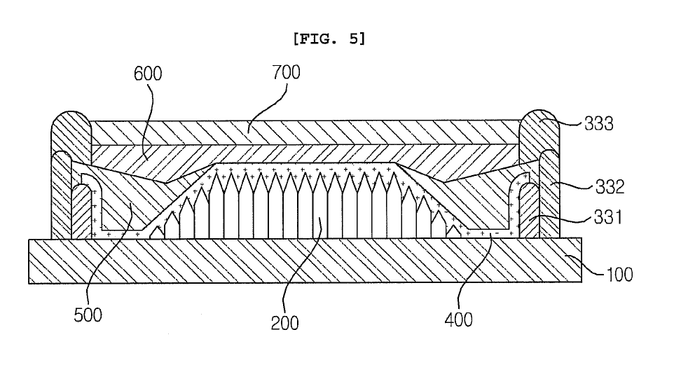

FIG. 5 illustrates a cross-section of the scintillator panel according to the fourth embodiment of the present invention. As illustrated in FIG. 5, the scintillator panel according to the fourth embodiment of the present invention is configured such that a scintillator layer 200 is formed on a substrate 100, a first dam 331 is formed on the substrate 100 to be spaced apart by a predetermined interval from the peripheral edge of the scintillator layer 200, and a second dam 332 is formed around the first dam 331.

As such, the first dam 331 is formed to be lower than and the second dam 332 to be higher than the maximum height of the scintillator layer 200.

Furthermore, the sequence in which the first dam 331 and the second dam 332 are formed is not necessarily limited to the above, and the sequence of formation of the second dam 332 first and then the first dam 331 is possible.

Before a protective layer 400 is formed, a masking layer is formed to protect an electrode unit on the surface of an imaging device separated from the peripheral edge of the scintillator layer 200, and the protective layer 400 is formed on the surface of the substrate 100 having the masking layer.

The protective layer 400 is cut along the first dam 331 positioned around the peripheral edge of the scintillator layer 200, and the masking layer and the protective layer 400 formed thereon are removed. Thus, the protective layer 400 only exists up to a portion of the surface of the first dam 331.

Cutting the protective layer 400 and removing the masking layer and the protective layer 400 formed thereon may be easily performed without damaging the surface of the substrate nor the electrode unit by cutting the protective layer 400, irradiating the masking layer with UV light to cause the UV tape to lose its adhesive force, and stripping the masking layer and the protective layer 400 formed thereon.

When the protective layer 400 is cut and removed in this way, the protective layer 400 is formed on the surface of the scintillator layer 200 and the area therearound, and the portion of the surface of the first dam 331, as illustrated in FIG. 5.

Also, a first coating layer 500 is formed on the protective layer 400 to be disposed in a space between the peripheral surface of the scintillator layer 200 and the second dam 332. Thus, the first coating layer 500 covers the surface of the first dam 331.

Also, a third dam 333 is formed on the first dam 331 and the second dam 332.

A second coating layer 600 is formed on the first coating layer 500 and the protective layer 400 on which no first coating layer 500 was formed, and a reflective layer 700 is formed on the second coating layer 600.

Alternatively, the sequence of formation of the second coating layer 600, the third dam 333 and then the reflective layer 700 is possible.

The first coating layer 500 covers the portion of the surface of the first dam 331 from which the protective layer 400 was removed so as to prevent the penetration of moisture.

The third dam 333 covers the first coating layer 500 and the second dam 332 so as to prevent the penetration of moisture, and also is provided in the form of a wall having a predetermined height around the reflective layer 700 which is to be formed, thus defining a space in which the reflective layer 700 may be formed.

The first coating layer 500 and the second coating layer 600 compensate for the inclined peripheral surface of the scintillator layer 200, whereby the flatness of the reflective layer 700 formed on the second coating layer 600 is made uniform. When the flatness of the reflective layer 700 is maintained uniform in this way, the defective rates of the scintillator panel may be reduced.

A scintillator panel according to a fifth embodiment of the present invention is described below.

### Fifth Embodiment

In the fifth embodiment of the present invention, portions of the description which would overlap with those of the first embodiment are omitted.

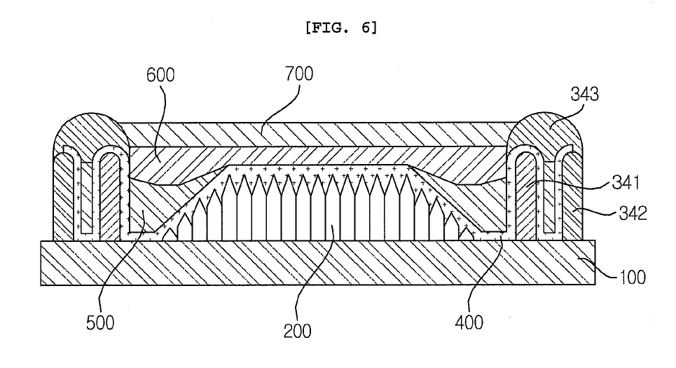

FIG. 6 illustrates a cross-section of the scintillator panel according to the fifth embodiment of the present invention. As illustrated in FIG. 6, the scintillator panel according to the fifth embodiment of the present invention is configured such that a scintillator layer 200 is formed on a substrate 100, a first dam 341 is formed on the substrate 100 to be spaced apart by a predetermined interval from the peripheral edge of the scintillator layer 200, and a second dam 342 is spaced apart by a predetermined interval from the outer surface of the first dam 341. This predetermined interval may be altered.

Before a protective layer 400 is formed, a masking layer is formed to protect an electrode unit on the surface of an imaging device separated from the peripheral edge of the scintillator layer 200, and the protective layer 400 is formed on the surface of the substrate 100 having the masking layer.

The protective layer 400 is cut along the second dam 342 positioned around the peripheral edge of the scintillator layer 200, and the masking layer and the protective layer 400 formed thereon are removed. Thereby, the protective layer 400 only exists up to the surface of the first dam 341 and the surface of the substrate between the first dam 341 and the second dam 342, and a portion of the surface of the second dam 342.

Cutting the protective layer 400 and removing the masking layer and the protective layer 400 formed thereon may be easily performed without damaging the surface of the substrate nor the electrode unit by cutting the protective layer 400, irradiating the masking layer with UV light to cause the UV tape to lose its adhesive force, and stripping the masking layer and the protective layer 400 formed thereon.

When the protective layer 400 is cut and removed in this way, the protective layer 400 is formed on the surface of the scintillator layer 200 and the area therearound, the surface of the first dam 341, the surface of the substrate between the first dam 341 and the second dam 342, and the portion of the surface of the second dam 342, as illustrated in FIG. 6.

A first coating layer 500 is formed in a space between the peripheral surface of the scintillator layer 200 and the first dam 341 and in a space between the first dam 341 and the second dam 342.

Also, a third dam 343 is formed on the first dam 341 and the second dam 342.

A second coating layer 600 is formed on the first coating layer 500 and the protective layer 400 on which no first coating layer 500 was formed, and a reflective layer 700 is formed on the second coating layer 600.

The third dam 343 covers the portion of the surface of the second dam 342 from which the protective layer 400 was removed and makes the first dam 341 and the second dam 342 airtight so as to prevent moisture from penetrating into the scintillator layer 200, and also is provided in the form of a wall having a predetermined height around the reflective layer 700 which is to be formed, thus defining a space in which the reflective layer 700 may be formed.

The first coating layer 500 formed between the first dam 341 and the second dam 342 covers the protective layer 400 to prevent the penetration of moisture.

Furthermore, the first coating layer 500 and the second coating layer 600 compensate for the inclined peripheral surface of the scintillator layer 200, whereby the flatness of the reflective layer 700 formed on the second coating layer 600 is made uniform. When the flatness of the reflective layer 700 is maintained uniform in this way, the defective rate of the scintillator panel may be reduced.

The first to fifth embodiments may be applied to a direct deposition process. Below, a scintillator panel according to a sixth embodiment of the present invention which may be applied to an indirect deposition process is described.

### Sixth Embodiment

In the sixth embodiment of the present invention, portions of the description which would overlap with those of the first embodiment are omitted.

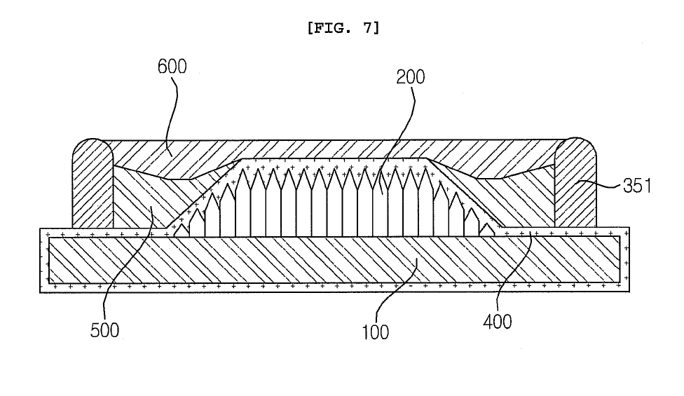

FIG. 7 illustrates a cross-section of the scintillator panel according to the sixth embodiment of the present invention. As illustrated in FIG. 7, the scintillator panel according to the sixth embodiment of the present invention is configured such that a scintillator layer 200 is formed on a substrate 100, and a protective layer 400 is formed on the entire surface of the substrate.

Also, a dam 351 is formed on the substrate 100 to be spaced apart by a predetermined interval from the peripheral edge of the scintillator layer 200.

A first coating layer 500 is formed in a space between the peripheral surface of the scintillator layer 200 and the dam 351.

Further, a second coating layer 600 is formed on the first coating layer 500 and the protective layer 400 on which no first coating layer 500 was formed.

The first coating layer 500 compensates for the inclined peripheral surface of the scintillator layer 200, whereby the flatness of the second coating layer 600 is made uniform thus enhancing a force of adhesion to an imaging device.

The substrate 100 may include a polymer film such as an aluminum plate, a metal plate, glass, a quartz substrate, a carbon substrate (graphite), polycarbonate (PC), polymethylmethacrylate (PMMA), polyimide (PI), polyether sulfone (PES), polyethylene naphthalate (PEN), acrylonitrile butadiene styrene (ABS) copolymers, etc.

A scintillator panel according to a seventh embodiment of the present invention is described below.

### Seventh Embodiment

In the seventh embodiment of the present invention, portions of the description which would overlap with those of the first embodiment are omitted.

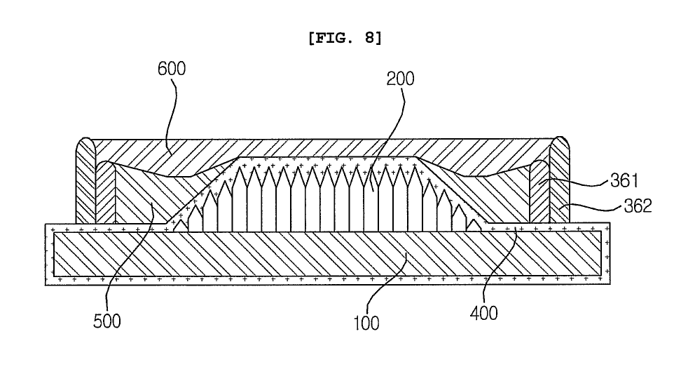

FIG. 8 illustrates a cross-section of the scintillator panel according to the seventh embodiment of the present invention. The scintillator panel according to the seventh embodiment of the present invention is configured such that a scintillator layer 200 is formed on a substrate 100, and a protective layer 400 is formed on the entire surface of the substrate.

Also, a first dam 361 is formed on the substrate 100 to be spaced apart by a predetermined interval from the peripheral edge of the scintillator layer 200, and a second dam 362 is formed around the first dam 361. As such, the second dam 362 is formed to be higher than the first dam 361.

Further, a first coating layer 500 is formed in a space between the peripheral surface of the scintillator layer 200 and the first dam 361.

A second coating layer 600 is formed on the first coating layer 500 and the protective layer 400 on which no first coating layer 500 was formed.

The first coating layer 500 compensates for the inclined peripheral surface of the scintillator layer 200, whereby the flatness of the second coating layer 600 is made uniform thus enhancing a force of adhesion to an imaging device.

The substrate 100 may include a polymer film such as an aluminum plate, a metal plate, glass, a quartz substrate, a carbon substrate (graphite), PC, PMMA, PI, PES, PEN, ABS copolymers, etc.

As described hereinbefore, the present invention provides a scintillator panel and a method of manufacturing the same. The present invention can be applied to a radiation image sensor.

In the scintillator panel and the method of manufacturing the same according to the present invention, penetration by moisture can be effectively prevented thus enhancing durability of the scintillator panel, and also the flatness of the scintillator panel can be maintained constant, thus minimizing defects in subsequent processes. Thereby an X-ray detector using a radiation image sensor according to the present invention can be prevented from producing deteriorated images after extended use.

The effects of the present invention are not limited to the above, and the other effects which are not mentioned should be able to be apparent to and understood by those skilled in the art from the above description.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A scintillator panel, comprising:
a substrate;
a scintillator layer formed on the substrate and comprising a plurality of columnar crystals so that radiation is converted into light at a predetermined wavelength;
a dam structure formed on the substrate to be spaced apart by a predetermined interval from a peripheral edge of the scintillator layer;
a protective layer formed on a surface of the scintillator layer, a surface of the substrate defined between the scintillator layer and the dam structure, and a portion of a surface of the dam structure;
a first coating layer formed on the protective layer to be disposed in a space between a peripheral surface of the scintillator layer and the dam structure; and
a second coating layer formed on the first coating layer and the protective layer.

2. The scintillator panel of claim 1, wherein the dam structure comprises a first dam formed on the substrate around the peripheral edge of the scintillator layer and a second dam formed on the first dam.

3. The scintillator panel of claim 1, wherein the dam structure comprises a first dam formed on the substrate around the peripheral edge of the scintillator layer, a second dam formed around the first dam, and a third dam formed on the first dam and the second dam.

4. The scintillator panel of claim 3, wherein the first dam is formed to be lower than a maximum height of the scintillator layer, and the second dam is formed to be higher than the maximum height of the scintillator layer.

5. The scintillator panel of claim 4, wherein the protective layer is formed on a portion of a surface of the first dam, and the first coating layer is formed in a space between the peripheral surface of the scintillator layer and the second dam.

6. The scintillator panel of claim 3, wherein the second dam is spaced apart by a predetermined interval from an outer surface of the first dam.

7. The scintillator panel of claim 6, wherein the first coating layer is formed between the first dam and the second dam.

8. The scintillator panel of claim 1, wherein the dam structure comprises a first dam formed on the substrate around the peripheral edge of the scintillator layer, a second dam formed around the first dam, a third dam formed around the second dam, and a fourth dam formed on the first dam, the second dam and the third dam.

9. The scintillator panel of claim 8, wherein the first dam is formed to be lower than a maximum height of the scintillator layer, and the second dam is formed to be higher than the maximum height of the scintillator layer.

10. The scintillator panel of claim 9, wherein the protective layer is formed on a portion of a surface of the first dam, and the first coating layer is formed in a space between the peripheral surface of the scintillator layer and the second dam.

11. The scintillator panel of claim 1, wherein a reflective layer is formed on the second coating layer, and the reflective layer comprises particles for reflecting the light at a predetermined wavelength, the particles comprising at least one selected from among TiO₂, LiF, MgF₂, SiO₂, Al₂O₃, MgO, SiN, CaF₂, NaCl, KBr, KCl, AgCl, SiNO₃, Au, SiO, AlO, B₄C, and BNO₃.

12. The scintillator panel of claim 1, wherein the protective layer comprises Parylene.

13. The scintillator panel of claim 1, wherein the first coating layer comprises a UV curable resin.

14. The scintillator panel of claim 1, wherein the first coating layer comprises a thermosetting resin.

15. The scintillator panel of claim 1, wherein the second coating layer comprises a thermosetting resin.

16. A scintillator panel, comprising:
a substrate;
a scintillator layer formed on the substrate and comprising a plurality of columnar crystals so that radiation is converted into light at a predetermined wavelength;
a protective layer formed on the scintillator layer and an entire surface of the substrate;
a dam structure formed on the protective layer around a peripheral edge of the scintillator layer;
a first coating layer formed on the protective layer to be disposed in a space between a peripheral surface of the scintillator layer and the dam structure; and
a second coating layer formed on the first coating layer and the protective layer.

17. The scintillator panel of claim 16, wherein the dam structure comprises a first dam formed on the substrate around the peripheral edge of the scintillator layer and a second dam formed on the first dam.

18. The scintillator panel of claim 17, wherein the second dam is formed to be higher than the first dam.

19. The scintillator panel of claim 16, wherein the protective layer comprises Parylene.

20. The scintillator panel of claim 16, wherein the first coating layer comprises a UV curable resin.

21. The scintillator panel of claim 16, wherein the first coating layer comprises a thermosetting resin.

22. The scintillator panel of claim 16, wherein the second coating layer comprises a thermosetting resin.
